(19) United States
(12) Patent Application Publication
(10) Pub. No.: US 2026/0197755 A1
(43) Pub. Date: Jul. 9, 2026

(54) METHOD FOR PERFORMING POWER SAVING OPTIMIZATION CONTROL IN WIRELESS COMMUNICATION SYSTEM, AND ASSOCIATED APPARATUS

(71) Applicant: MEDIATEK INC., Hsinchu City (TW)

(72) Inventor: I-Cheng Tsai, Hsinchu City (TW)

(73) Assignee: MEDIATEK INC., Hsinchu City (TW)

(21) Appl. No.: 19/011,498

(22) Filed: Jan. 6, 2025

(51) Int. Cl. H04W 52/02

(52) U.S. Cl. CPC H04W 52/0209

(57) ABSTRACT

A method for performing power saving optimization control in a wireless communication system and associated apparatus are provided, where a non-access-point station (non-AP STA) multi-link device (MLD) may be equipped with multi-band capabilities for communicating with at least one other device. For example, the method may include: determining whether the non-AP STA MLD is in connection with the at least one other device in a multi-link operation (MLO) mode; and in response to determining that the non-AP STA MLD is in connection with the at least one other device in the MLO mode, starting executing an application-based power save (application-based PS) procedure to determine a link number of at least one link between the non-AP STA MLD and the at least one other device, for performing power saving by a current user scenario.

### BACKGROUND

The present invention is related to communication control, and more particularly, to a method for performing power saving optimization control in a wireless communication system, and associated apparatus such as a wireless transceiver device in the wireless communication system.

According to the related art, access points (APs) and non-access-point stations (non-AP STAs) may be configured to have dual-band or tri-band capabilities and support multi-link operation (MLO) features. However, power consumption may increase due to multi-link data transmission. For example, a multi-link device (MLD) performing the multi-link data transmission may turn on hardware components respectively corresponding to multiple predetermined radio frequency bands to support the MLO features, causing the overall power consumption to significantly increase. Especially, in a dense environment, extending the original per-link design to multi-link may result in extra power consumption, and regarding any link among all links, the MLD may keep waiting until an air clean to send status and/or a clear-to-send (CTS) frame are detected. It seems that there is no proper suggestion for solving the problems in the related art. Thus, a novel method and associated architecture are needed for solving the problems without introducing any side effect or in a way that is less likely to introduce a side effect.

### SUMMARY

It is an objective of the present invention to provide a method for performing power saving optimization control in a wireless communication system, and associated apparatus such as a wireless transceiver device (e.g., a non-AP STA MLD) in the wireless communication system, in order to solve the above-mentioned problems.

At least one embodiment of the present invention provides a method for performing power saving optimization control in a wireless communication system, where a non-AP STA MLD is equipped with multi-band capabilities for communicating with at least one other device. For example, the method may comprise: determining whether the non-AP STA MLD is in connection with the at least one other device in a multi-link operation (MLO) mode; and in response to determining that the non-AP STA MLD is in connection with the at least one other device in the MLO mode, starting executing an application-based power save (application-based PS) procedure to determine a link number of at least one link between the non-AP STA MLD and the at least one other device, for performing power saving by a current user scenario.

At least one embodiment of the present invention provides a non-AP STA MLD for performing power saving optimization control in a wireless communication system, where the non-AP STA MLD is one of multiple devices within the wireless communication system such as that mentioned above. The non-AP STA MLD may comprise a processing circuit that is arranged to control operations of the non-AP STA MLD. The non-AP STA MLD may further comprise at least one communication control circuit that is coupled to the processing circuit and arranged to perform communication control, wherein the aforementioned at least one communication control circuit is arranged to perform wireless communication operations with at least one other device among the multiple devices for the non-AP STA MLD. In addition, the non-AP STA MLD is equipped with multi-band capabilities for communicating with the at least one other device. For example, the non-AP STA MLD is arranged to determine whether the non-AP STA MLD is in connection with the at least one other device in a multi-link operation (MLO) mode; and in response to determining that the non-AP STA MLD is in connection with the at least one other device in the MLO mode, the non-AP STA MLD is arranged to start executing an application-based PS procedure to determine a link number of at least one link between the non-AP STA MLD and the at least one other device, for performing power saving by a current user scenario.

It is an advantage of the present invention that, through proper design, the method of the present invention, as well as the associated apparatus such as the non-AP STA MLD, can determine the link number to be equal to a first predetermined link number among multiple predetermined link numbers or any other predetermined link number among the multiple predetermined link numbers that is greater than the first predetermined link number, for dynamically performing power saving by the current user scenario while maintaining performance of the non-AP STA MLD. For example, when determining that a first predetermined throughput condition is met, the non-AP STA MLD can set the link number as the first predetermined link number to keep the non-AP STA MLD being linked to the at least one other device via the best link (e.g., one of multiple links that are used before starting executing the application-based PS procedure) and disable any other link, for performing power saving by the current user scenario. In addition, the method of the present invention and the associated apparatus such as the non-AP STA MLD can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system and a setup control scheme for AP and non-AP MLDs therein according to an embodiment of the present invention.

FIG. 2 is a diagram illustrating a clean channel power saving control scheme according to an embodiment of the present invention.

FIG. 3 illustrates, in the lower half part thereof, an MLD-based power saving control scheme of a method for performing power saving optimization control in a wireless communication system such as that shown in FIG. 1 according to an embodiment of the present invention, where a per-link power saving control scheme may be illustrated in the upper half part of FIG. 3 for better comprehension.

FIG. 4 illustrates a multi-radio power saving control scheme of the method according to an embodiment of the present invention.

FIG. 5 illustrates an application-based power saving control scheme of the method according to an embodiment of the present invention.

FIG. 6 illustrates a best link selection control scheme of the method according to an embodiment of the present invention.

FIG. 7 illustrates a main working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

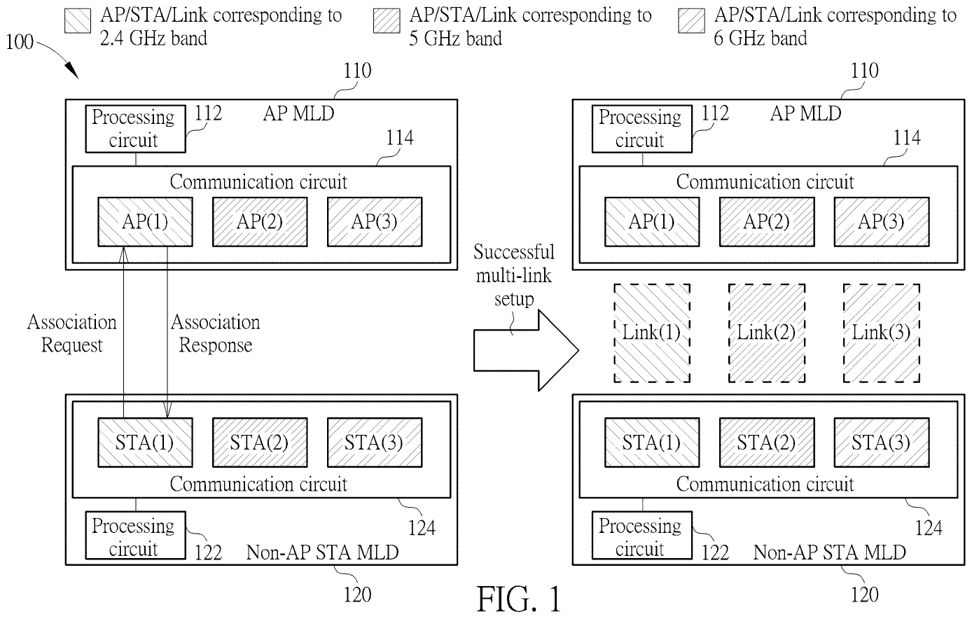

FIG. 1 is a diagram illustrating a wireless communication system 100 and a setup control scheme for AP and non-AP MLDs therein according to an embodiment of the present invention. For better comprehension, the wireless communication system 100, as well as any wireless transceiver device therein, may be compatible or backward-compatible to one or more versions of the Institute of Electrical and Electronics Engineers (IEEE) 802.11 standards, but the present invention is not limited thereto. The wireless communication system 100 may comprise multiple wireless transceiver devices, and the multiple wireless transceiver devices may comprise AP and non-AP STA devices such as the AP and non-AP MLDs. As shown in the left half part of FIG. 1, among the multiple wireless transceiver devices within the wireless communication system 100, the AP device such as the AP MLD 110 may comprise a processing circuit 112, at least one communication control circuit (e.g., one or more communication control circuits), which may be collectively referred to as the communication control circuit 114, as well as at least one antenna (e.g., one or more antennas) of the communication control circuit 114, and the STA device such as the non-AP STA MLD 120 may comprise a processing circuit 122, at least one communication control circuit (e.g., one or more communication control circuits), which may be collectively referred to as the communication control circuit 124, as well as at least one antenna (e.g., one or more antennas) of the communication control circuit 124. The processing circuit 112 can be arranged to control operations of the AP MLD 110 to make the AP MLD 110 act as at least one AP in the wireless communication system 100, such as multiple APs integrated into the AP MLD 110, and the communication control circuit 114 can be arranged to perform communication control, and more particularly, perform wireless communication operations with the non-AP STA MLD 120 (or the communication control circuit 124 thereof) for the AP MLD 110. The processing circuit 122 can be arranged to control operations of the non-AP STA MLD 120 to make the non-AP STA MLD 120 act as at least one STA in the wireless communication system 100, such as multiple STAs integrated into the non-AP STA MLD 120, and the communication control circuit 124 can be arranged to perform communication control, and more particularly, perform wireless communication operations with the AP MLD 110 (or the communication control circuit 114 thereof) for the non-AP STA MLD 120. According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP MLD 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the non-AP STA MLD 120 may include, but are not limited to: a multifunctional mobile phone, a laptop computer and an all-in-one computer.

The AP MLD 110 and the non-AP STA MLD 120 may be configured to set up multiple links {Link( )} such as the links Link(1), Link(2) and Link(3) respectively corresponding to multiple predetermined radio frequency bands such as the 2.4 gigahertz (GHz) band, the 5 GHz band and the 6 GHz band to support MLO features. For example, the AP MLD 110 may be equipped with multiple APs such as the APs AP(1), AP(2) and AP(3) respectively corresponding to the 2.4 GHz band, the 5 GHz band and the 6 GHz band, and the non-AP STA MLD 120 may be equipped with multiple non-AP STAs such as the STAs STA(1), STA(2) and STA(3) respectively corresponding to the 2.4 GHz band, the 5 GHz band and the 6 GHz band. The non-AP STA MLD 120 may utilize a STA STA(x) corresponding to a radio frequency band among the multiple non-AP STAs, such as the STA STA(1), to send an association request to the AP MLD 110, and the AP MLD 110 may utilize an AP AP(x) corresponding to the same radio frequency band among the multiple APs, such as the AP AP(1), to send an association response to the non-AP STA MLD 120, to complete a successful multi-link setup. As a result, the AP MLD 110 and the non-AP STA MLD 120 may establish the links {Link(1), Link(2), Link(3)} between the APs {AP(1), AP(2), AP(3)} and the STAs {STA(1), STA(2), STA(3)}, respectively. Based on the MLO architecture shown in FIG. 1, the AP MLD 110 and the non-AP STA MLD 120 may communicate with each other by using the links {Link(1), Link(2), Link(3)}.

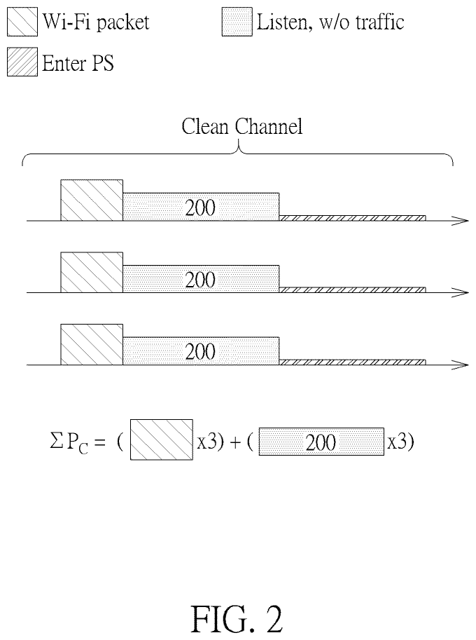

FIG. 2 is a diagram illustrating a clean channel power saving control scheme according to an embodiment of the present invention, where the three timing sequences within the timing chart shown in FIG. 2 may correspond to the links {Link(1), Link(2), Link(3)}, respectively, but the present invention is not limited thereto. For any link Link( ) among the links {Link(1), Link(2), Link(3)}, the aforementioned any wireless transceiver device such as the non-AP STA MLD 120 may perform effective power saving control to effectively switch among different power consumption levels in order to save power. For example, transmitting (or receiving) Wi-Fi packets via the aforementioned any link Link( ), listening to the channel used by the aforementioned any link Link( ) during a time period without (w/o) traffic (labeled “Listen, w/o traffic” for brevity) and controlling the sub-circuit (e.g., the STA STA( )) corresponding to the aforementioned any link Link( ) to enter a doze state (for example, in a power save (PS) mode) for power saving (labeled “Enter PS” for brevity) may correspond to a higher power consumption level, a lower power consumption level and a lowest power consumption level, respectively. When all channels used by the links {Link(1), Link(2), Link(3)} are clean channels without any overlapping basic service set (OBSS) interference (e.g., the interference due to the OBSS), the total power consumption of the non-AP STA MLD 120 without considering the power consumption of the doze state in the PS mode may comprise the summation ΣP_{C} of the respective power consumption {P_{C}} of transmitting (or receiving) Wi-Fi packets via the links {Link(1), Link(2), Link(3)} and listening to the channels used by the links {Link(1), Link(2), Link(3)} during the time period of 200 milliseconds (ms) without traffic (labeled “200” for brevity), such as the summation ΣP_{C} of three times the power consumption P_{C} of transmitting (or receiving) at least one Wi-Fi packet via one link Link( ) among the links {Link(1), Link(2), Link(3)} and three times the power consumption P_{C} of listening to the channel used by one link Link( ) among the links {Link(1), Link(2), Link(3)} during the time period of 200 ms without traffic (respectively labeled “×3” and “×3” for indicating the linear combination in a graphical equation for illustrative purposes as shown in the bottommost of FIG. 2).

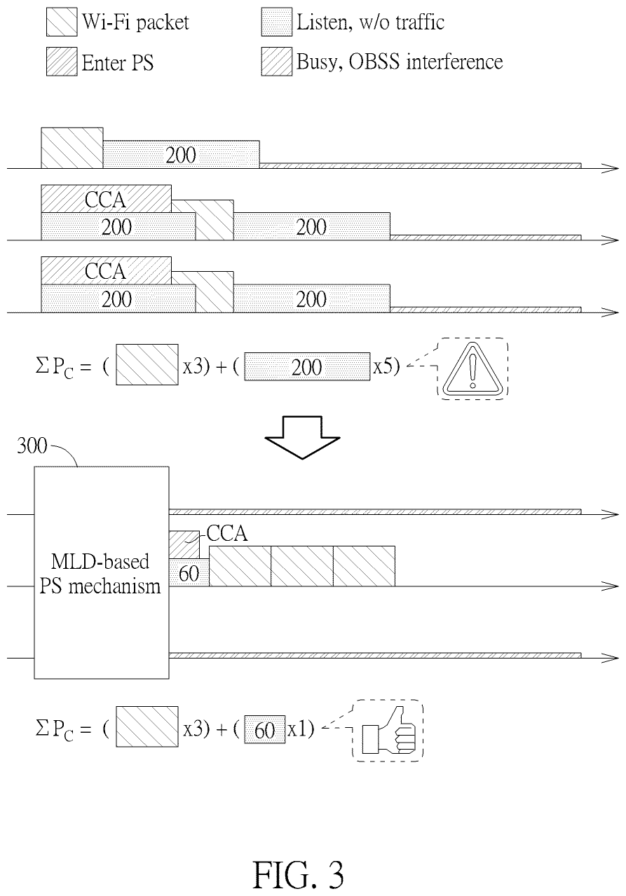

FIG. 3 illustrates, in the lower half part thereof, an MLD-based power saving control scheme of a method for performing power saving optimization control in a wireless communication system (e.g., the wireless communication system shown in FIG. 1) according to an embodiment of the present invention, where a per-link power saving control scheme may be illustrated in the upper half part of FIG. 3 for better comprehension. The three timing sequences within any timing chart among the two timing charts respectively shown in the upper half part and the lower half part of FIG. 3 may correspond to the links {Link(1), Link(2), Link(3)}, respectively. The aforementioned any wireless transceiver device such as the non-AP STA MLD 120 may perform clear channel assessment (CCA) to monitor and appraise the radio frequency (RF) medium, and may determine that the radio frequency medium is busy on the channels with the OBSS interference (labeled “Busy, OBSS interference” for brevity). Assume that one or more functions of the wireless communication system 100 may be temporarily disabled to allow the AP MLD 110 and the non-AP STA MLD 120 to operate according to the per-link power saving control scheme shown in the upper half part of FIG. 3, but the present invention is not limited thereto. Based on the per-link power saving control scheme, for the case of the OBSS interference in a dense environment, it will be hard for the non-AP STA MLD 120 to enter the doze state in the PS mode, causing extra power consumption of the non-AP STA MLD 120, and the total power consumption of the non-AP STA MLD 120 may significantly increase, and more particularly, may be significantly greater than the total power consumption in the clean channel environment. For example, when the OBSS interference exists on two channels among the channels used by the links {Link(1), Link(2), Link(3)}, the total power consumption of the non-AP STA MLD 120 without considering the power consumption of the doze state in the PS mode may comprise the summation ΣP_{C} of the respective power consumption {P_{C}} of transmitting (or receiving) Wi-Fi packets via the links {Link(1), Link(2), Link(3)} and listening to the channels used by the links {Link(1), Link(2), Link(3)} during the time period of 200 ms without traffic as well as the extra power consumption {P_{C}} of listening to the two channels on which the OBSS interference exists, such as the summation ΣP_{C} of three times the power consumption P_{C} of transmitting (or receiving) at least one Wi-Fi packet via one link Link( ) among the links {Link(1), Link(2), Link(3)} and five times the power consumption P_{C} of listening to the channel used by one link Link( ) among the links {Link(1), Link(2), Link(3)} during the time period of 200 ms without traffic (respectively labeled “×3” and “×5” for indicating the linear combination in a graphical equation for illustrative purposes as shown in the bottommost of the upper half part of FIG. 3).

As shown in the lower half part of FIG. 3, the wireless communication system 100 (or the AP MLD 110 and the non-AP STA MLD 120 therein) may operate according to the MLD-based power saving control scheme, for using an MLD-based power save (MLD-based PS) mechanism 300 of the MLD-based power saving control scheme to dynamically limit the awake link count of the awake links {Link( )} among the multiple links {Link( )} (e.g., the links Link(1), Link(2) and Link(3)) or the awake sub-circuit count of the awake sub-circuits (e.g., the STAs {STA( )}) corresponding to the awake links {Link( )} among multiple sub-circuits (e.g., the STAs {STA(1), STA(2), STA(3)}) of the communication control circuit 124 to be as small as possible, in order to achieve a better overall performance. Taking the non-AP STA MLD 120 as an example of the aforementioned any wireless transceiver device within the wireless communication system 100, the non-AP STA MLD 120 may be equipped with multi-band capabilities for communicating with at least one other device (e.g., the AP MLD 110) within the wireless communication system 100, and the associated operations may comprise:
(1) the non-AP STA MLD 120 may determine whether the non-AP STA MLD 120 is in connection with the aforementioned at least one other device (e.g., the AP MLD 110) in an MLO mode; and
(2) in response to determining that the non-AP STA MLD 120 is in connection with the aforementioned at least one other device (e.g., the AP MLD 110) in the MLO mode, the non-AP STA MLD 120 may start executing an application-based PS procedure to determine a link number of at least one link between the non-AP STA MLD 120 and the aforementioned at least one other device, such as the awake link count of the awake links {Link( )} (or the awake sub-circuit count of the awake sub-circuits), for performing power saving by a current user scenario; but the present invention is not limited thereto. According to some embodiments, the AP MLD 110 and the non-AP STA MLD 120 (or any other set MLDs such as a set of non-AP STA MLDs {120} or a set of AP MLDs {110}) may be taken as examples of the aforementioned any wireless transceiver device and the aforementioned at least one other device within the wireless communication system 100, respectively, as long as the implementation of the present invention will not be hindered. In addition, the current user scenario may represent a predetermined user scenario among multiple predetermined user scenarios. For example, the non-AP STA MLD 120 may start executing the application-based PS procedure to determine the link number such as the awake link count at least according to the current user scenario among the multiple predetermined user scenarios, for performing power saving by the current user scenario.

During executing the application-based PS procedure, the non-AP STA MLD 120 may determine the best link Link_{BEST} among the multiple links {Link( )} in order to keep the non-AP STA MLD 120 being linked to the aforementioned at least one other device (e.g., the AP MLD 110) via the best link Link_{BEST} and disable any other link Link( ) among the multiple links {Link( )}, for performing power saving by the current user scenario. For example, when the OBSS interference exists on the aforementioned two channels among the channels used by the links {Link(1), Link(2), Link(3)}, the total power consumption of the non-AP STA MLD 120 without considering the power consumption of the doze state in the PS mode may comprise the summation ΣP_{C} of the respective power consumption {P_{C}} of transmitting (or receiving) Wi-Fi packets via the best link Link( ) among the links {Link(1), Link(2), Link(3)} and listening to the channel used by the best link Link( ) among the links {Link(1), Link(2), Link(3)} during the time period of 60 ms without traffic (labeled “60” for brevity), such as the summation ΣP_{C} of three times the power consumption P_{C} of transmitting (or receiving) at least one Wi-Fi packet via one link Link( ) among the links {Link(1), Link(2), Link(3)} and the power consumption P_{C} of listening to the channel used by one link Link( ) among the links {Link(1), Link(2), Link(3)} during the time period of 60 ms without traffic (respectively labeled “×3” and “×1” for indicating the linear combination in a graphical equation for illustrative purposes as shown in the bottommost of the lower half part of FIG. 3).

In most mobile-device user scenarios, small traffic scenarios such as web browsing and gaming may have been common. In such cases, having just one link such as the best link Link_{BEST} among the multiple links {Link( )} is usually sufficient. The non-AP STA MLD 120 operating according to the MLD-based power saving control scheme can prevent wasting power and minimize the power consumption, having no need to wait for the channel (e.g., the clear channel) to send, especially in dense environments.

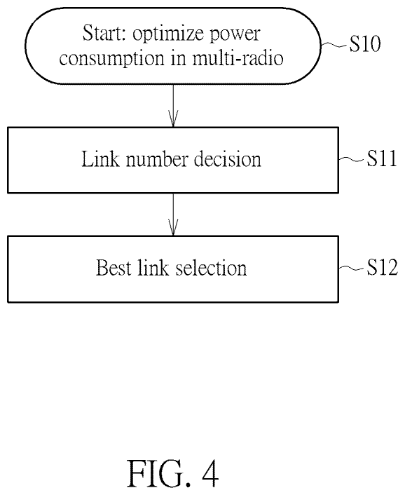

FIG. 4 illustrates a multi-radio power saving control scheme of the method according to an embodiment of the present invention. At a first time point (e.g., the time point t1) before starting executing the application-based PS procedure, the non-AP STA MLD may be linked to the aforementioned at least one other device (e.g., the AP MLD 110) via the multiple links {Link( )} (e.g., the links Link(1), Link(2) and Link(3)) in the MLO mode. Afterward, during executing the application-based PS procedure, the non-AP STA MLD 120 may start in Step S10 for optimizing the power consumption in multi-radio, perform the link number decision in Step S11 to determine the link number such as the awake link count, and perform the best link selection in Step S12 to select the best link Link_{BEST} from the multiple links {Link( )}, but the present invention is not limited thereto. When there is a need, the non-AP STA MLD 120 may refer to one or more predetermined factors to determine which link(s) {Link( )} among the multiple links {Link( )} should be kept awakened, where the associated sub-circuit(s) (e.g., the associated STA(s) {STA( )}) corresponding to the link(s) {Link( )} should be kept in the awake state rather than the doze state. For example, when the throughput is less than 100 megabits per second (Mbps), the non-AP STA MLD 120 may keep the best link Link_{BEST} awake. In some examples, the throughput condition for determining which link(s) {Link( )} among the multiple links {Link( )} should be kept awakened may vary.

For better comprehension, the multi-radio power saving control scheme may be illustrated with the working flow shown in FIG. 4, but the present invention is not limited thereto. According to some embodiments, one or more steps may be added, deleted, or changed in the working flow shown in FIG. 4.

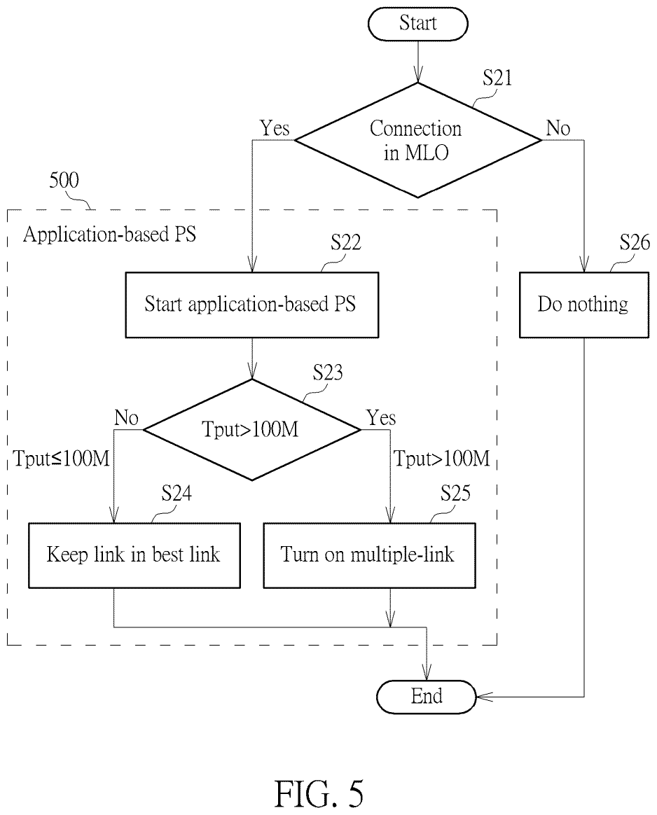

FIG. 5 illustrates an application-based power saving control scheme of the method according to an embodiment of the present invention. The aforementioned application-based PS procedure such as the application-based PS procedure 500 (labeled “Application-based PS” for brevity) may comprise Steps S22, S23, S24 and S25 and the associated partial working flows.

In Step S21, the non-AP STA MLD 120 may determine whether the non-AP STA MLD 120 is in connection with the aforementioned at least one other device (e.g., the AP MLD 110) in the MLO mode. If Yes, Step S22 is entered; if No, Step S26 is entered.

In Step S22, when determining that the non-AP STA MLD 120 is in connection with the aforementioned at least one other device (e.g., the AP MLD 110) in the MLO mode, the non-AP STA MLD 120 may start executing the application-based PS procedure 500 (labeled “Start application-based PS” for brevity), in order to determine the link number such as the awake link count, for performing power saving by the current user scenario.

During the application-based PS procedure 500, the non-AP STA MLD 120 may determine the current user scenario for determining whether a first predetermined throughput condition among at least one predetermined throughput condition is met to generate a determination result (e.g., one of the two determination results “Yes” and “No” of Step S23), and selectively determine the link number to be equal to a first predetermined link number among multiple predetermined link numbers or any other predetermined link number among the multiple predetermined link numbers that is greater than the first predetermined link number according to the determination result, for dynamically performing power saving by the current user scenario. For example, the first predetermined throughput condition may represent the throughput condition of the throughput being less than or equal to 100 Mbps (labeled “Tput≤100M” for brevity). More particularly, determining whether the first predetermined throughput condition among the aforementioned at least one predetermined throughput condition is met may further comprise determining whether the first predetermined throughput condition or a second predetermined throughput condition among the multiple predetermined throughput condition is met, and the second predetermined throughput condition may represent the throughput condition of the throughput being greater than 100 Mbps (labeled “Tput>100M” for brevity).

In Step S23, the non-AP STA MLD 120 may determine whether the throughput (Tput) is greater than 100 Mbps (labeled “Tput>100M” for brevity). If Yes, Step S25 is entered; if No, Step S24 is entered.

In Step S24, in response to the determination result indicating that the first predetermined throughput condition (e.g., Tput≤100M) is met, the non-AP STA MLD 120 may determine the link number to be equal to the first predetermined link number, in order to keep the non-AP STA MLD 120 being linked to the aforementioned at least one other device (e.g., the AP MLD 110) via the best link Link_{BEST} among the multiple links {Link( )} and disable any other link Link( ) among the multiple links {Link( )} (labeled “Keep link in best link” for brevity), for performing power saving by the current user scenario, where the first predetermined link number may be equal to one.

In Step S25, in response to the determination result indicating that the second predetermined throughput condition (e.g., Tput>100M) is met, the non-AP STA MLD 120 may determine the link number to be greater than the first predetermined link number, to allow data transmission to be performed via more than one link Link( ) (labeled “Turn on multiple-link” for brevity), for dynamically performing power saving by the current user scenario while maintaining performance of the non-AP STA MLD 120.

The current user scenario of the time point at which Step S23 is executed may represent

one of the multiple predetermined user scenarios mentioned above. For example, the multiple predetermined user scenarios may comprise the aforementioned small traffic scenarios such as the scenarios of executing multiple small traffic applications (e.g., one or more web browsers and one or more games), respectively. If it is detected that all Wi-Fi packets to be transmitted (or received) are configured for transmitting (or receiving) information for at least one portion of small traffic applications (e.g., a portion of small traffic applications or all small traffic applications) among the multiple small traffic applications, which may indicate that the current user scenario belongs to the small traffic scenarios, the non-AP STA MLD 120 may determine in Step S23 that the first predetermined throughput condition (e.g., Tput≤100M) is met, and therefore execute Step S24, where having just one link such as the best link Link_{BEST} among the multiple links {Link( )} is usually sufficient; otherwise, the non-AP STA MLD 120 may determine in Step S23 that the second predetermined throughput condition (e.g., Tput>100M) is met, and therefore execute Step S25.

In Step S26, the non-AP STA MLD 120 may do nothing to allow the working flow shown in FIG. 5 to come to the end. For example, the non-AP STA MLD 120 may operate according to any other control scheme to perform any other processing afterward.

For better comprehension, the application-based power saving control scheme may be illustrated with the working flow shown in FIG. 5, but the present invention is not limited thereto. According to some embodiments, one or more steps may be added, deleted, or changed in the working flow shown in FIG. 5. For example, at least one partial working flow among a first partial working flow comprising Steps S23 and S24 and a second partial working flow comprising Steps S23 and S25 within the application-based PS procedure 500 may be executed multiple times to form at least one loop, and the non-AP STA MLD 120 may dynamically change the link number according to the latest user scenario. For example, assuming that t1<t2<t3, a series of operations of the application-based PS procedure 500 may comprise: at a subsequent time point such as the time point t2, the non-AP STA MLD 120 may determine the link number to be equal to the first predetermined link number (e.g., a minimum link number such as one) among the multiple predetermined link numbers, for dynamically performing power saving by the latest user scenario of the subsequent time point such as the time point t2; and at another subsequent time point such as the time point t3, the non-AP STA MLD 120 may determine the link number to be greater than the first predetermined link number, for dynamically performing power saving by the latest user scenario of the other subsequent time point such as the time point t3 while maintaining performance of the non-AP STA MLD 120. This is for illustrative purposes only, and is not meant to be a limitation of the present invention. In another example, the non-AP STA MLD 120 may determine the link number to be greater than the first predetermined link number at the time point t2, for dynamically performing power saving by the latest user scenario of the time point t2 while maintaining performance of the non-AP STA MLD 120, and determine the link number to be equal to the first predetermined link number at the time point t3, for dynamically performing power saving by the latest user scenario of the time point t3. In some examples, assuming that t1<t2<t3<t4<t5 . . . , the non-AP STA MLD 120 may determine the link number to be equal to the first predetermined link number at the time point t2, determine the link number to be greater than the first predetermined link number at the time point t3, determine the link number to be equal to the first predetermined link number at the time point t4, determine the link number to be greater than the first predetermined link number at the time point t5, and the rest may be deduced by analogy. For brevity, similar descriptions for these embodiments are not repeated in detail here.

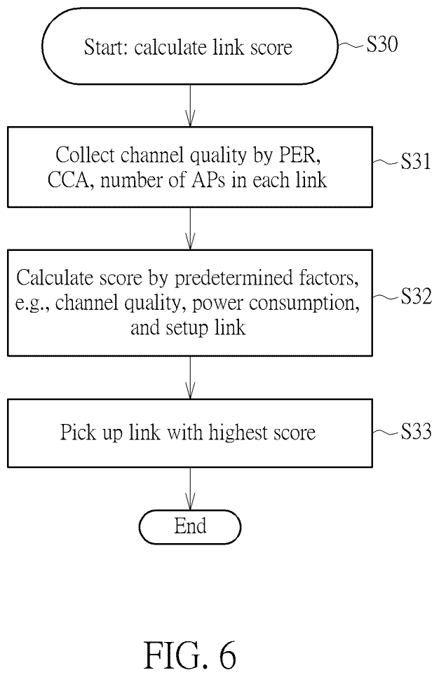

FIG. 6 illustrates a best link selection control scheme of the method according to an embodiment of the present invention. During executing the aforementioned application-based PS procedure such as the application-based PS procedure 500 shown in FIG. 5, the non-AP STA MLD 120 may determine the best link Link_{BEST} among the multiple links {Link( )} according to at least one predetermined factor, in order to keep the non-AP STA MLD 120 being linked to the aforementioned at least one other device (e.g., the AP MLD 110) via the best link Link_{BEST} and disable any other link Link( ) among the multiple links {Link( )}, for performing power saving by the current user scenario. The aforementioned at least one predetermined factor may comprise one or a combination of the setup link, the power consumption in each link Link( ) among the multiple links {Link( )}, and the channel quality. More particularly, the aforementioned at least one predetermined factor may comprise multiple predetermined factors such as the setup link, the power consumption in each link Link( ) among the multiple links {Link( )}, and the channel quality.

During determining the best link Link_{BEST} among the multiple links {Link( )} according to the aforementioned at least one predetermined factor, the non-AP STA MLD 120 may start in Step S30 for calculating the link scores, perform the channel quality collection on the channels used by the multiple links {Link( )} in Step S31 to collect the channel quality by the packet error rate (PER), the CCA, the number of APs, etc. in each link Link( ) among the multiple links {Link( )}, perform score calculation for the multiple links {Link( )} in S32 to calculate a score SCORE( ) of any link Link( ) among the multiple links {Link( )} according to the multiple predetermined factors regarding the aforementioned any link Link( ) in order to calculate the respective scores {SCORE( )} of the multiple links {Link( )} by the multiple predetermined factors (e.g., the setup link, the power consumption, and the channel quality), and determine or pick up the link Link( ) having the highest score SCORE( ) among the respective scores {SCORE( )} of the multiple links {Link( )} to be the best link Link_{BEST} in Step S33 (labeled “Pick up link with highest score” for brevity). For example, the multiple predetermined factors regarding the aforementioned any link Link( ) may be expressed with preliminary scores, and the non-AP STA MLD 120 may determine the best link Link_{BEST} among the multiple links {Link( )} according to the summation of the multiple predetermined factors (or the respective preliminary scores thereof) regarding the aforementioned any link Link( ).

For better comprehension, the best link selection control scheme may be illustrated with the working flow shown in FIG. 6, but the present invention is not limited thereto. According to some embodiments, one or more steps may be added, deleted, or changed in the working flow shown in FIG. 6. For example, the non-AP STA MLD 120 may determine the best link Link_{BEST} among the multiple links {Link( )} according to a linear combination of the multiple predetermined factors (or the respective preliminary scores thereof) regarding the aforementioned any link Link( ). More particularly, the multiple predetermined factors may comprise a first predetermined factor FACTOR1 such as a first preliminary score corresponding to whether the aforementioned any link Link( ) is the setup link (e.g., FACTOR1=1 for the case of the aforementioned any link Link( ) is the setup link, or FACTOR1=0 for the case of the aforementioned any link Link( ) is not the setup link), a second predetermined factor FACTOR2 such as a second preliminary score having a negative correlation with (or being inverse proportional to) the power consumption in the aforementioned any link Link( ), and a third predetermined factor FACTOR3 such as a third preliminary score indicting the channel quality of the channel used by the aforementioned any link Link( ), and the non-AP STA MLD 120 may calculate the score SCORE( ) of the aforementioned any link Link( ) as follows:

$$SCORE ( ) = ( W 1 * FACTOR 1 ) + ( W 2 * FACTOR 2 ) + ( W 3 * FACTOR 3 ) ;$$

where “W1”, “W2” and “W3” may represent the weights of the predetermined factors FACTOR1, FACTOR2 and FACTOR3 in the linear combination, respectively. In addition, when collecting the third predetermined factor FACTOR3, the non-AP STA MLD 120 may monitor multiple sub-factors of the third predetermined factor FACTOR3, and the multiple sub-factors may include but are not limited to: a first sub-factor FACTOR3_{A} such as a first secondary preliminary score having a negative correlation with (or being inverse proportional to) the number of APs (e.g., the APs causing the OBSS interference) on the channel used by the aforementioned any link Link( ), a second sub-factor FACTOR3_{B} such as a second secondary preliminary score having a negative correlation with (or being inverse proportional to) the per-link PER in the history such as the per-link PER of the aforementioned any link Link( ) during a predetermined PER monitoring period (e.g., one minute, or any other length of time period), and a third sub-factor1 FACTOR3_{C} such as a third secondary preliminary score having a positive correlation with (or being proportional to) the per-link CCA slot count of the channel used by the aforementioned any link Link( ) during a predetermined CCA monitoring period (e.g., one minute, or any other length of time period) for determining whether the radio frequency medium is idle or busy. Additionally, the non-AP STA MLD 120 may calculate the third predetermined factor FACTOR3 regarding the aforementioned any link Link( ) as follows:

$$FACTOR 3 = ( W {3}_{A} * FACTOR {3}_{A} ) + ( W {3}_{B} * FACTOR {3}_{B} ) + ( W {3}_{C} * FACTOR {3}_{C} ) ;$$

where “W3_{A}”, “W3_{B}” and “W3_{C}” may represent the weights of the sub-factors FACTOR3_{A}, FACTOR3_{B} and FACTOR3_{C}, respectively. For example, the third sub-factor FACTOR3_{C} such as the third secondary preliminary score may be equal to the per-link CCA slot count. During monitoring the third sub-factor FACTOR3_{C} such as the per-link CCA slot count, if the energy detection value of the packet from any interference source (e.g., any AP causing the OBSS interference) on the channel used by the aforementioned any link Link( ) reaches (or is greater than or equal to) an energy detection threshold EDₜₕ, the non-AP STA MLD 120 may hold (or prevent increasing) the per-link CCA slot count; otherwise, in a situation where no energy detection value of any packet from any interference source (e.g., any AP causing the OBSS interference) on the channel used by the aforementioned any link Link( ) reaches the energy detection threshold EDₜₕ, the non-AP STA MLD 120 may increase the per-link CCA slot count with a predetermined increment such as one for every CCA slot (e.g., 9 microseconds (μs)). For brevity, similar descriptions for these embodiments are not repeated in detail here.

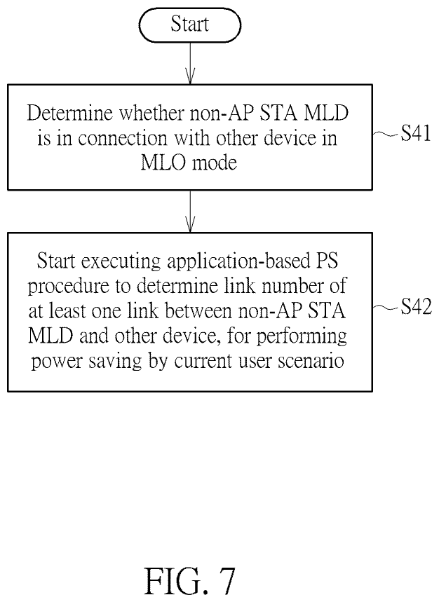

FIG. 7 illustrates a main working flow of the method according to an embodiment of the present invention. The aforementioned any wireless transceiver device within the wireless communication system 100, such as the non-AP STA MLD 120, may operate according to the working flow shown in FIG. 7 in order to dynamically limit the awake link count of the awake links {Link( )} (or the awake sub-circuit count of the awake sub-circuits (e.g., the STAs {STA( )}) corresponding to the awake links {Link( )}) to be as small as possible, in order to achieve the better overall performance.

In Step S41, the non-AP STA MLD 120 may determine whether the non-AP STA MLD 120 is in connection with the aforementioned at least one other device (e.g., the AP MLD 110) in the MLO mode.

In Step S42, when determining that the non-AP STA MLD 120 is in connection with the aforementioned at least one other device (e.g., the AP MLD 110) in the MLO mode, the non-AP STA MLD 120 may start executing the application-based PS procedure to determine the link number of the aforementioned at least one link between the non-AP STA MLD 120 and the aforementioned at least one other device, such as the awake link count of the awake links {Link( )}, for performing power saving by the current user scenario.

For example, the application-based PS procedure mentioned in Step S42 may be implemented as the application-based PS procedure 500 shown in FIG. 5, but the present invention is not limited thereto. In some examples, at least one partial working flow among the first partial working flow comprising Steps S23 and S24 and the second partial working flow comprising Steps S23 and S25 within the application-based PS procedure 500 may be executed multiple times to form at least one loop, and the non-AP STA MLD 120 may dynamically change the link number according to the latest user scenario. For brevity, similar descriptions for this embodiment are not repeated in detail here.

For better comprehension, the method may be illustrated with the working flow shown in FIG. 7, but the present invention is not limited thereto. According to some embodiments, one or more steps may be added, deleted, or changed in the working flow shown in FIG. 7. For example, during executing the application-based PS procedure, the non-AP STA MLD 120 may send a first null data frame carrying a first power management (PM) bit and at least one other null data frame carrying at least one other PM bit via the best link Link_{BEST} and at least one other link Link( ), respectively, with the first PM bit and the aforementioned at least one other PM bit being set as zero and one, respectively, in order to keep the non-AP STA MLD 120 being linked to the aforementioned at least one other device via the best link Link_{BEST} and disable the aforementioned at least one other link Link( ), for performing power saving by the current user scenario. For example, the first PM bit being set as zero may indicate that the best link Link_{BEST} is an awake link, and that the sub-circuit (e.g., the STA STA( )) corresponding to the best link Link_{BEST} is an awake STA. In addition, the aforementioned at least one other PM bit being set as one may indicate that the aforementioned at least one other link Link( ) is at least one doze/non-awake link, and that at least one sub-circuit (e.g., at least one STA STA( )) corresponding to the aforementioned at least one other link Link( ) is at least one doze/non-awake sub-circuit (e.g., at least one doze/non-awake STA). For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing power saving optimization control in a wireless communication system, wherein a non-access-point station (non-AP STA) multi-link device (MLD) is equipped with multi-band capabilities for communicating with at least one other device, the method comprising:
determining whether the non-AP STA MLD is in connection with the at least one other device in a multi-link operation (MLO) mode; and
in response to determining that the non-AP STA MLD is in connection with the at least one other device in the MLO mode, starting executing an application-based power save (application-based PS) procedure to determine a link number of at least one link between the non-AP STA MLD and the at least one other device, for performing power saving by a current user scenario.

2. The method of claim 1, wherein the current user scenario represents a predetermined user scenario among multiple predetermined user scenarios; and starting executing the application-based PS procedure to determine the link number of the at least one link between the non-AP STA MLD and the at least one other device for performing power saving by the current user scenario further comprises:
starting executing the application-based PS procedure to determine the link number of the at least one link between the non-AP STA MLD and the at least one other device at least according to the current user scenario among the multiple predetermined user scenarios, for performing power saving by the current user scenario.

3. The method of claim 1, wherein the current user scenario represents a predetermined user scenario among multiple predetermined user scenarios; and the application-based PS procedure comprises:
determining the current user scenario for determining whether a first predetermined throughput condition among at least one predetermined throughput condition is met to generate a determination result; and
selectively determining the link number to be equal to a first predetermined link number among multiple predetermined link numbers or any other predetermined link number among the multiple predetermined link numbers that is greater than the first predetermined link number according to the determination result, for dynamically performing power saving by the current user scenario.

4. The method of claim 3, wherein the non-AP STA MLD is linked to the at least one other device via multiple links in the MLO mode at a first time point before starting executing the application-based PS procedure; and the application-based PS procedure further comprises:
in response to the determination result indicating that the first predetermined throughput condition is met, determining the link number to be equal to the first predetermined link number, in order to keep the non-AP STA MLD being linked to the at least one other device via a best link among the multiple links and disable any other link among the multiple links, for performing power saving by the current user scenario, wherein the first predetermined link number is equal to one.

5. The method of claim 3, wherein the at least one predetermined throughput condition comprises multiple predetermined throughput conditions; determining whether the first predetermined throughput condition among the at least one predetermined throughput condition is met further comprises determining whether the first predetermined throughput condition or a second predetermined throughput condition among the multiple predetermined throughput condition is met; and the application-based PS procedure further comprises:
in response to the determination result indicating that the second predetermined throughput condition is met, determining the link number to be greater than the first predetermined link number, to allow data transmission to be performed via more than one link, for dynamically performing power saving by the current user scenario while maintaining performance of the non-AP STA MLD.

6. The method of claim 1, wherein the non-AP STA MLD is linked to the at least one other device via multiple links in the MLO mode at a first time point before starting executing the application-based PS procedure; and the application-based PS procedure comprises:
determining a best link among the multiple links according to at least one predetermined factor, in order to keep the non-AP STA MLD being linked to the at least one other device via the best link and disable any other link among the multiple links, for performing power saving by the current user scenario.

7. The method of claim 6, wherein the at least one predetermined factor comprises one or a combination of a setup link, a power consumption in each link among the multiple links, and a channel quality.

8. The method of claim 6, wherein the at least one predetermined factor comprises multiple predetermined factors; and determining the best link among the multiple links according to the at least one predetermined factor further comprises:
calculating a score of any link among the multiple links according to the multiple predetermined factors regarding the any link; and
determining a link having a highest score among respective scores of the multiple links to be the best link.

9. The method of claim 1, wherein the non-AP STA MLD is linked to the at least one other device via multiple links in the MLO mode at a first time point before starting executing the application-based PS procedure; and the application-based PS procedure comprises:
sending a first null data frame carrying a first power management (PM) bit and at least one other null data frame carrying at least one other PM bit via a best link and at least one other link, respectively, with the first PM bit and the at least one other PM bit being set as zero and one, respectively, in order to keep the non-AP STA MLD being linked to the at least one other device via the best link and disable the at least one other link, for performing power saving by the current user scenario.

10. The method of claim 1, wherein the non-AP STA MLD is linked to the at least one other device via multiple links in the MLO mode at a first time point before starting executing the application-based PS procedure; and the application-based PS procedure comprises:
at a subsequent time point, determining the link number to be equal to a first predetermined link number among multiple predetermined link numbers, for dynamically performing power saving by a latest user scenario of the subsequent time point; and
at another subsequent time point, determining the link number to be greater than the first predetermined link number, for dynamically performing power saving by a latest user scenario of the other subsequent time point while maintaining performance of the non-AP STA MLD.

11. A non-access-point station (non-AP STA) multi-link device (MLD), for performing power saving optimization control in a wireless communication system, the non-AP STA MLD comprising:
a processing circuit, arranged to control operations of the non-AP STA MLD; and
at least one communication control circuit, coupled to the processing circuit, arranged to perform communication control, wherein the at least one communication control circuit is arranged to perform wireless communication operations with at least one other device within the wireless communication system for the non-AP STA MLD, wherein the non-AP STA MLD is equipped with multi-band capabilities for communicating with the at least one other device;
wherein:
the non-AP STA MLD is arranged to determine whether the non-AP STA MLD is in connection with the at least one other device in a multi-link operation (MLO) mode; and
in response to determining that the non-AP STA MLD is in connection with the at least one other device in the MLO mode, the non-AP STA MLD is arranged to start executing an application-based power save (application-based PS) procedure to determine a link number of at least one link between the non-AP STA MLD and the at least one other device, for performing power saving by a current user scenario.

12. The non-AP STA MLD of claim 11, wherein the current user scenario represents a predetermined user scenario among multiple predetermined user scenarios; and the non-AP STA MLD is arranged to start executing the application-based PS procedure to determine the link number of the at least one link between the non-AP STA MLD and the at least one other device at least according to the current user scenario among the multiple predetermined user scenarios, for performing power saving by the current user scenario.

13. The non-AP STA MLD of claim 11, wherein the current user scenario represents a predetermined user scenario among multiple predetermined user scenarios; and the application-based PS procedure comprises:
determining the current user scenario for determining whether a first predetermined throughput condition among at least one predetermined throughput condition is met to generate a determination result; and
selectively determining the link number to be equal to a first predetermined link number among multiple predetermined link numbers or any other predetermined link number among the multiple predetermined link numbers that is greater than the first predetermined link number according to the determination result, for dynamically performing power saving by the current user scenario.

14. The non-AP STA MLD of claim 13, wherein the non-AP STA MLD is linked to the at least one other device via multiple links in the MLO mode at a first time point before starting executing the application-based PS procedure; and the application-based PS procedure further comprises:
in response to the determination result indicating that the first predetermined throughput condition is met, determining the link number to be equal to the first predetermined link number, in order to keep the non-AP STA MLD being linked to the at least one other device via a best link among the multiple links and disable any other link among the multiple links, for performing power saving by the current user scenario, wherein the first predetermined link number is equal to one.

15. The non-AP STA MLD of claim 13, wherein the at least one predetermined throughput condition comprises multiple predetermined throughput conditions; determining whether the first predetermined throughput condition among the at least one predetermined throughput condition is met further comprises determining whether the first predetermined throughput condition or a second predetermined throughput condition among the multiple predetermined throughput condition is met; and the application-based PS procedure further comprises:
in response to the determination result indicating that the second predetermined throughput condition is met, determining the link number to be greater than the first predetermined link number, to allow data transmission to be performed via more than one link, for dynamically performing power saving by the current user scenario while maintaining performance of the non-AP STA MLD.

16. The non-AP STA MLD of claim 11, wherein the non-AP STA MLD is linked to the at least one other device via multiple links in the MLO mode at a first time point before starting executing the application-based PS procedure; and the application-based PS procedure comprises:
determining a best link among the multiple links according to at least one predetermined factor, in order to keep the non-AP STA MLD being linked to the at least one other device via the best link and disable any other link among the multiple links, for performing power saving by the current user scenario.

17. The non-AP STA MLD of claim 16, wherein the at least one predetermined factor comprises one or a combination of a setup link, a power consumption in each link among the multiple links, and a channel quality.

18. The non-AP STA MLD of claim 16, wherein the at least one predetermined factor comprises multiple predetermined factors; and during determining the best link among the multiple links according to the at least one predetermined factor, the non-AP STA MLD is arranged to calculate a score of any link among the multiple links according to the multiple predetermined factors regarding the any link, and determine a link having a highest score among respective scores of the multiple links to be the best link.

19. The non-AP STA MLD of claim 11, wherein the non-AP STA MLD is linked to the at least one other device via multiple links in the MLO mode at a first time point before starting executing the application-based PS procedure; and the application-based PS procedure comprises:
sending a first null data frame carrying a first power management (PM) bit and at least one other null data frame carrying at least one other PM bit via a best link and at least one other link, respectively, with the first PM bit and the at least one other PM bit being set as zero and one, respectively, in order to keep the non-AP STA MLD being linked to the at least one other device via the best link and disable the at least one other link, for performing power saving by the current user scenario.

20. The non-AP STA MLD of claim 11, wherein the non-AP STA MLD is linked to the at least one other device via multiple links in the MLO mode at a first time point before starting executing the application-based PS procedure; and the application-based PS procedure comprises:
at a subsequent time point, determining the link number to be equal to a first predetermined link number among multiple predetermined link numbers, for dynamically performing power saving by a latest user scenario of the subsequent time point; and
at another subsequent time point, determining the link number to be greater than the first predetermined link number, for dynamically performing power saving by a latest user scenario of the other subsequent time point while maintaining performance of the non-AP STA MLD.
